(19) United States
(12) Patent Application Publication
(10) Pub. No.: US 2015/0146898 A1
(43) Pub. Date: May 28, 2015

(54) SOUND FIELD SUPPORTING DEVICE AND SOUND FIELD SUPPORTING SYSTEM

(71) Applicant: Yamaha Corporation, Hamamatsu-Shi (JP)

(72) Inventors: Hideki SAKANASHI, Hamamatsu-shi (JP); Sungyoung KIM, Hamamatsu-shi (JP)

(21) Appl. No.: 14/611,004

(22) Filed: Jan. 30, 2015

Related U.S. Application Data
(63) Continuation of application No. PCT/JP2013/070132, filed on Jul. 25, 2013.

(30) Foreign Application Priority Data
Jul. 31, 2012 (JP) 2012-170330

(51) Int. Cl. H04S 7/00

(52) U.S. Cl. CPC H04S 7/302
USPC 381/303

(57) ABSTRACT

Listening position is disposed on or in the proximity of the plane same as that of the diaphragm of a planar loudspeaker. An audio sound emitted from a main loudspeaker being a sound source is received by a microphone of a sound field supporting device to be outputted from the planar loudspeaker as a sound wave according to a signal of an indirect sound component generated in a DSP. There are few sounds that directly reach the listening position from the planar loudspeaker, resulting in that reflected sounds reflected by wall surfaces, a ceiling, and the like in the room mainly reach the listening position. Accordingly, a user existing at the listening position hears mainly the indirect sound components reflected by the wall surfaces without feeling localization of the planar loudspeaker itself, and a sound field in which the indirect sound components resonate in the entire room can be provided.

### TECHNICAL FIELD

The invention relates to a device that supports a sound field in a listening space.

### BACKGROUND ART

Conventionally, there has been proposed a sound field supporting device capable of creating sound field feeling such that a user feels as if he/she were in a large space such as a hall even in a small space room by repeatedly performing an operation of inputting an audio signal according to a sound received by a microphone, supplying the audio signal to a FIR filter or the like to generate a reverberation signal, outputting the reverberation signal from a loudspeaker, and receiving the sound by the microphone again (see PTL1, for example).

Further, there has been also proposed a sound field supporting device that achieves a sound field as if a virtual sound source were generated by inputting an audio signal and generating a sound effect signal based on the audio signal to output it from plural loudspeakers placed around a listening position (see PTL2, for example).

### CITATION LIST

### Patent Literature

{PTL1} JP H10(1998)-069280 A

{PTL2} JP 2011-217068 A

### SUMMARY OF INVENTION

### {Technical Problem}

However, in the conventional sound field supporting device, direct sounds from a speaker reach a listener, and therefore sound images are localized at the position of the loudspeaker, resulting in that unnaturalness has been sometimes caused. Further, in such a system of the device in PTL2, it has been necessary to provide complicated wirings from a reproduction device or the like to respective plural loudspeakers in order to input audio signals.

Thus, the present invention has an object to provide a sound field supporting device that eliminates unnaturalness of feeling of localization of sound images by a loudspeaker and requires no complicated wirings to the loudspeaker.

{Solution to Problem}

A sound field supporting device of the invention includes: a loudspeaker whose directional characteristic is limited such that a sound wave is not outputted in a predetermined direction; a microphone disposed in the direction for which the directional characteristic is limited; and a signal processor configured to perform processing of inputting an audio signal representing a sound received by the microphone, generating a signal representing an indirect sound component based on the inputted audio signal, and outputting the signal via the loudspeaker.

As above, because of using the loudspeaker whose directional characteristic is limited such that a sound wave is not outputted in a predetermined direction, the sound field supporting device of the present invention can be disposed such that almost no direct sounds from the loudspeaker are allowed to reach a listening position. In this case, without unnaturalness caused by localization of sound images of the loudspeaker, a sound field such that indirect sound components (early-reflected sounds and reverberant sounds) resonate in the entire room can be provided. Further, since the sound field supporting device generates a signal representing an indirect sound component based on a sound received by the microphone and outputs the signal via the loudspeaker, there is no need to input an audio signal from a reproduction device or the like and no wirings to connect the reproduction device or the like are required.

As the above-described loudspeaker whose directional characteristic is limited, for example, a planar loudspeaker to output planar sound waves or a line sound source loudspeaker to output cylindrical sound waves is conceived. In the case of the planar loudspeaker, when the microphone is disposed in a plane same as that of a diaphragm of the planar loudspeaker, the microphone hardly receives sounds outputted from the planar loudspeaker, so that it is possible to dramatically suppress acoustic feedback. Further, in the case of the line sound source loudspeaker, when the microphone is disposed in the center axis direction along which the cylindrical sound waves are outputted, the microphone hardly receives sounds outputted from the line sound source loudspeaker, so that it is possible to dramatically suppress acoustic feedback.

Further, the microphone is preferably a directional microphone. The directional microphone is oriented to a sound source, thereby making it possible to receive sounds of the sound source at a high signal-to-noise ratio and to more effectively perform sound field support.

Incidentally, by constituting such that a wall surface is arranged in a direction in which the loudspeaker outputs a sound, indirect sound components outputted from the loudspeaker and reflected by the wall surface reaches the listening position, so that it is possible to more efficiently provide a sound field.

{Advantageous Effects of Invention}

According to the present invention, it is possible to provide a sound field such that sounds resonate in the entire room without feeling of localization of a loudspeaker. Further, there is no need to supply an audio signal from a reproduction device or the like, and no wirings to connect the reproduction device or the like are required.

### BRIEF DESCRIPTION OF DRAWINGS

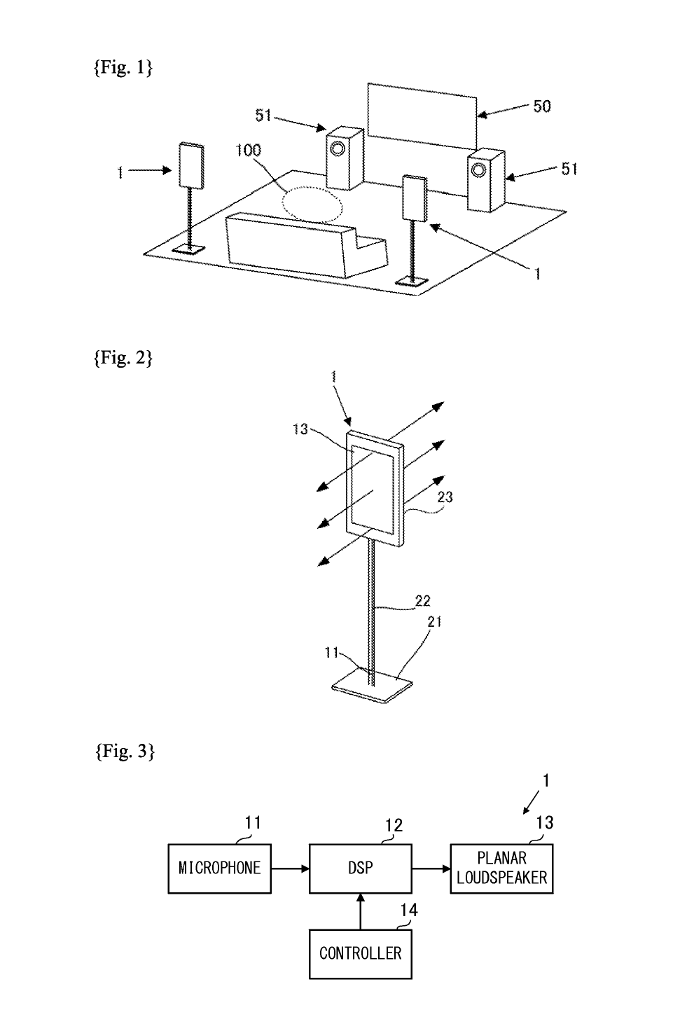

{FIG. 1} FIG. 1 is a schematic view of the interior of a room where a sound field supporting system is placed.

{FIG. 2} FIG. 2 is an appearance view of a sound field supporting device.

{FIG. 3} FIG. 3 is a block diagram illustrating the structure of the sound field supporting device.

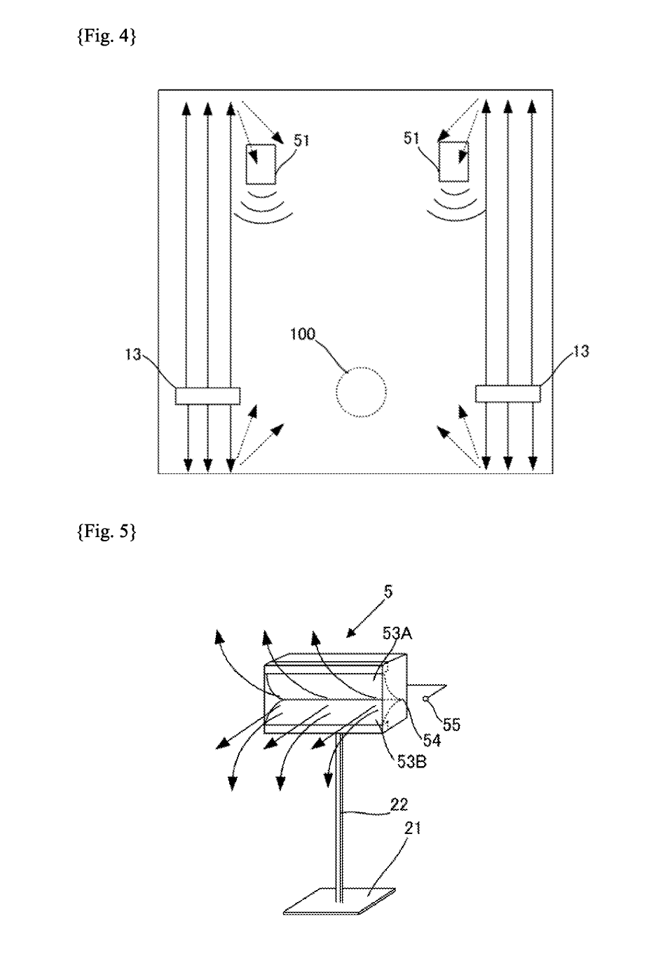

{FIG. 4} FIG. 4 is a schematic view illustrating paths of sounds outputted from sound sources and the sound field supporting devices.

{FIG. 5} FIG. 5 is an appearance view of a line sound source loudspeaker.

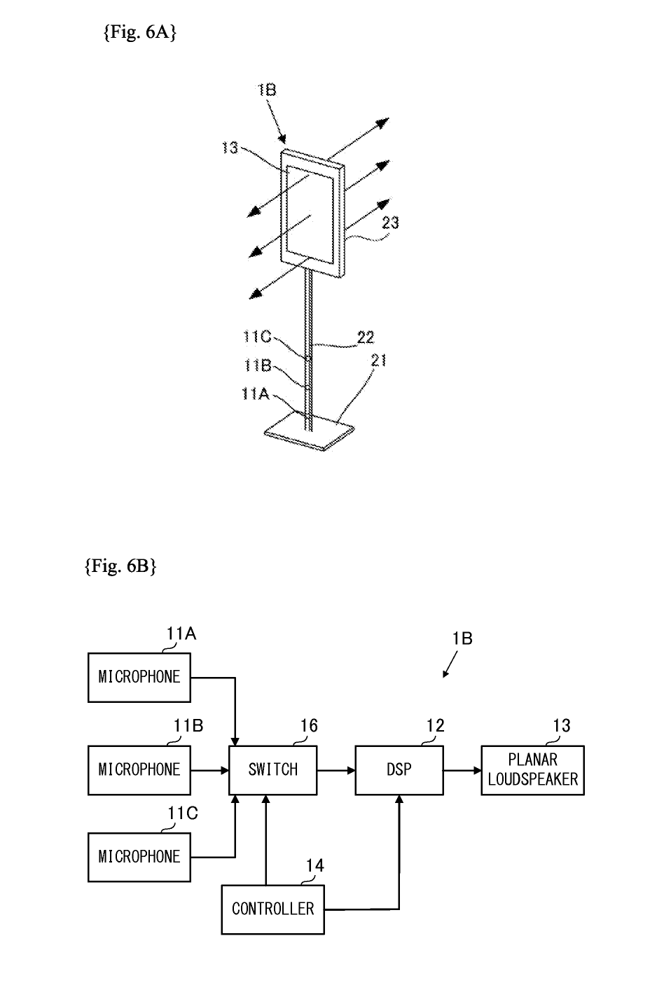

{FIG. 6A} FIG. 6A is an appearance view of a sound field supporting device according to a modified example 1.

{FIG. 6B} FIG. 6B is a block diagram of the sound field supporting device according to the modified example 1.

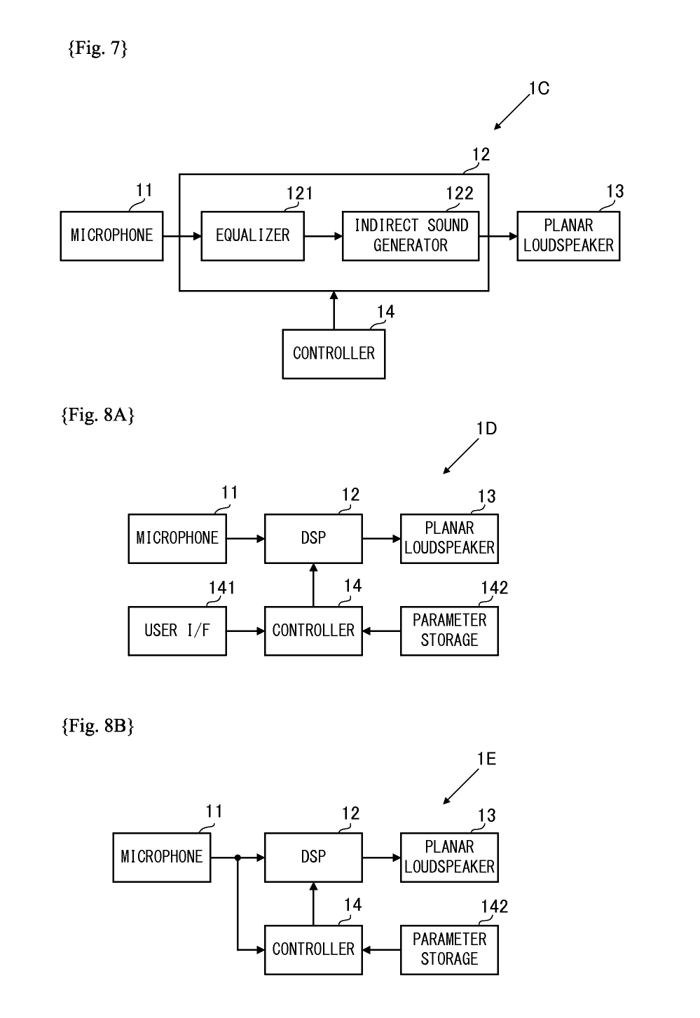

{FIG. 7} FIG. 7 is a block diagram of a sound field supporting device according to a modified example 2.

{FIG. 8A} FIG. 8A is a block diagram of a sound field supporting device according to a modified example 3.

{FIG. 8B} FIG. 8B is a block diagram of a sound field supporting device according to a modified example 4.

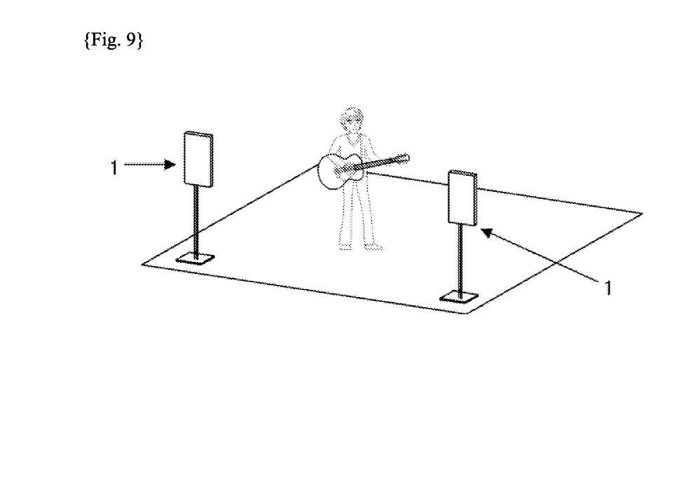

{FIG. 9} FIG. 9 is a schematic view of a state where the sound field supporting system is placed around a performer.

### DESCRIPTION OF EMBODIMENTS

FIG. 1 is a schematic view of the interior of a room where a sound field supporting system is placed. The sound field supporting system is formed by sound field supporting devices 1 placed around a listening position.

In FIG. 1, at the front of a listening position 100, a display 50 and main loudspeakers 51 used for watching and listening to contents are placed. In this example, an example where the two main loudspeakers 51 are placed on the left and right sides of the display 50 and left channel sounds and right channel sounds are outputted from the main loudspeakers 51 respectively is illustrated, but an aspect where a center channel loudspeaker and surround loudspeakers are placed and more channel sounds are outputted therefrom is also possible.

The sound field supporting devices 1 are each placed on the left and right sides of the listening position 100. As illustrated in FIG. 2, the sound field supporting device 1 is constituted by a plate-shaped stand 21 with its bottom surface in contact with a floor, a support post 22 extending vertically upward from a top surface of the stand 21, a microphone 11 attached to the support post 22, a plate frame 23 with its side surface supported by the support post 22, and a planar loudspeaker 13 provided at the center portion of the plate frame 23, in appearance.

The plate frame 23 has a thin plate shape and has an opening at the center portion. The planar loudspeaker 13 is provided in the opening portion. The planar loudspeaker 13 has a structure in which a sheet-shaped diaphragm is sandwiched by two fixed electrode plates. The planar loudspeaker 13 applies a voltage to the diaphragm and the fixed electrode plates and changes the voltage applied to the fixed electrode plates, to thereby change an electrostatic force. By this change in electrostatic force, the diaphragm is made to vibrate and sounds are outputted.

The planar loudspeaker 13 is a loudspeaker whose directional characteristic is limited so that sound waves are not outputted in a predetermined direction. The entire diaphragm of the planar loudspeaker 13 vibrates, so that the sound waves to be outputted become planar sound waves. Thus, the planar loudspeaker 13 outputs sound waves with strong directivity in the front direction and the rear direction, (which is the normal direction of the diaphragm), and as going farther from the front direction and the rear direction, the sound pressure level decreases suddenly, and sound waves are hardly outputted to a plane same as that of the diaphragm, (which excludes on the plane of the diaphragm). Thus, the sound waves outputted from the planar loudspeaker 13 are hardly incident on the microphone 11 disposed on the plane same as that of the diaphragm, (which excludes on the plane of the diaphragm).

Incidentally, sounds in opposite phase to each other are outputted in the front direction and in the rear direction of the planar loudspeaker 13, so that even if sound waves in a frequency band with weak directivity, in a low-frequency band in particular, sneak into the microphone 11, the sound waves outputted in the front direction and the rear direction of the planar loudspeaker 13 cancel with each other at the position of the microphone 11 on the plane same as that of the diaphragm. Therefore, there are few sound waves to be directly incident on the microphone 11 from the planar loudspeaker 13.

Note that the position where the microphone 11 is placed is not limited to the position illustrated in FIG. 2, and the microphone 11 may be placed at any position of the support post 22. Further, it may also be an aspect where the microphone 11 is placed on the plate frame 23 or the stand 21. That is, the microphone 11 only needs to be disposed on a plane same as that of the diaphragm of the planar loudspeaker 13.

Next, FIG. 3 is a block diagram illustrating the structure of the sound field supporting device 1. The sound field supporting device 1 includes a DSP 12 and a controller 14 in addition to the above-described microphone 11 and planar loudspeaker 13. The DSP 12 and the controller 14 are housed in a casing of the stand 21, for example. Incidentally, in this embodiment, a D/A converter, an A/D converter, and the like are omitted, and explanation is conducted on the assumption that signals to be transmitted through the sound field supporting device 1 are all digital signals unless otherwise described.

The controller 14 is a functional unit to integrally control the sound field supporting device 1, and performs various operations by unfolding programs stored in a medium such as a ROM (not-illustrated) into a RAM (not-illustrated).

The DSP 12 corresponds to a signal processor of the present invention, inputs an audio signal representing a sound received by the microphone 11, and generates a signal representing an indirect sound component (an early-reflected sound and a reverberant sound) based on the inputted audio signal. For example, the DSP 12 performs convolution of a reflected audio signal on the inputted audio signal and outputs the resultant signal, to thereby generate an early-reflected sound and a reverberant sound. Such processing is achieved by a FIR filter, for example. Parameters such as a delay time of the reflected audio signal, a level, and the number of taps are set by the controller 14.

The signal of the indirect sound component generated in the DSP 12 is outputted from the planar loudspeaker 13 as a sound wave. In this manner, the DSP 12 performs processing to input an audio signal outputted by the microphone 11 receiving sounds in a space including sounds outputted from the main loudspeakers 51, generate an audio signal representing an indirect sound component based on the inputted audio signal, and output the generated audio signal into the space via the planar loudspeaker 13. FIG. 4 is a view schematically illustrating how sound waves outputted from sound sources (the main loudspeakers 51) and the sound field supporting devices 1 propagate, from above the interior of the room illustrated in FIG. 1.

In an example of FIG. 4, an audio sound emitted from the main loudspeaker 51 being a sound source is received by the microphone 11 of the sound field supporting device 1 to be outputted from the planar loudspeaker 13 as a sound wave according to the signal of an indirect sound component generated in the DSP 12. As described above, the planar loudspeaker 13 outputs sound waves with strong directivity in the front direction and the rear direction, and thus hardly outputs sound waves onto the plane same as that of the diaphragm. Accordingly, as illustrated in FIG. 4, in the case where the listening position 100 is disposed on the plane same as that of the diaphragm of the planar loudspeaker 13 (or in the proximity of the plane), there are few sounds that directly reach the listening position 100 from the planar loudspeaker 13 (namely direct sounds), resulting in that reflected sounds reflected by wall surfaces, a ceiling, and the like in the room mainly reach the listening position 100.

Thus, a user existing at the listening position hears mainly the reflected sounds reflected by the wall surfaces, the ceiling, and the like in the room (namely, reflected sounds of the indirect sound components generated by the sound field supporting device 1). Therefore, the user perceives as if the indirect sound components generated by the sound field supporting device 1 resonated in the entire room without feeling localization of the planar loudspeaker 13 itself. As described above, even in a small space room, a sound field where the entire room resonates like a large space hall can be achieved.

Further, since the sound field supporting device 1 has the microphone 11 disposed in the plane same as that of the diaphragm of the planar loudspeaker 13, the sound waves outputted from the planar loudspeaker 13 do not sneak into the microphone 11, and thus howling can be suppressed. Note that the microphone 11 may be an omnidirectional microphone, but is preferably a directional microphone. In the case of a directional microphone, the direction in which sensitivity of the directional microphone becomes maximum is oriented in the direction of the main loudspeaker 51 being a sound source, thereby making it possible to receive sounds of the sound source at a high signal-to-noise ratio and to perform sound field support further effectively.

Further, the sound field supporting device 1 has a constitution to generate an indirect sound component (an early-reflected sound and a reverberant sound) based on a sound received by the microphone 11 and to output it via the planar loudspeaker 13. Accordingly, it is not necessary to input audio signals from a reproduction device or the like, and thus no wirings to connect the reproduction device or the like are required.

Further, it is also possible to generate indirect sound components by using a musical instrument, a human voice, and the like as a sound source, so that a user can perceive performance sounds of a musical instrument played by a player himself or herself or another player and singing sounds in a sound field such that the user feels as if he or she were in a large hall, just by placing the sound field supporting devices 1 around the player of the musical instrument or the listening position as illustrated in FIG. 9.

Incidentally, in the examples illustrated in FIG. 1 and FIG. 4, an example where the two sound field supporting devices 1 are placed in pairs across the listening position 100 of a user is illustrated, but an aspect where a larger number of the sound field supporting devices 1 are placed is possible, and further an aspect where only the single sound field supporting device 1 is placed is also possible.

Further, FIG. 1 to FIG. 4 illustrate the example where the planar loudspeaker is used as a loudspeaker whose directional characteristic is limited so that sound waves are not outputted in a predetermined direction, but it is also possible to use a loudspeaker in a different form. It is also possible to use a line sound source loudspeaker illustrated in FIG. 5, for example.

FIG. 5 is an appearance view of a line sound source loudspeaker 5. The same numerals are given to components of the line sound source loudspeaker 5 in common with those of the planar loudspeaker 13 illustrated in FIG. 2, and their explanations are omitted. Nine arrow-attached lines coming out of the line sound source loudspeaker 5 illustrated in FIG. 5 express propagation directions of sound waves emitted from the line sound source loudspeaker 5.

The line sound source loudspeaker 5 is one in which one side of a rectangular-shaped diaphragm 53A and one side of a rectangular-shaped diaphragm 53B are matched on a predetermined surface to be joined, the other side of the diaphragm 53A and the other side of the diaphragm 53B on the sides opposite to the sides on which the diaphragm 53A and the diaphragm 53B are joined are respectively supported by a rigid wall, and the two diaphragm 53A and diaphragm 53B are disposed in a shape opening radially in an up and down direction in the drawing. A voice coil 54 is disposed on the surface of the two diaphragm 53A and diaphragm 53B being joined and the voice coil 54 is sandwiched by magnets (not illustrated), and thereby a magnetic circuit is formed. Then, an audio signal is inputted to the voice coil 54, and thereby the diaphragms 53 vibrate and sound waves are emitted from the line sound source loudspeaker 5. The line sound source loudspeaker 5 as above is one called Ryffel-type loudspeaker, for example.

In this case, in the up and down direction of the diaphragm 53A and the diaphragm 53B in FIG. 5, sound waves with wide directivity, which is about 180 degrees, are emitted, but in the axis direction in which the diaphragm 53A and the diaphragm 53B are joined to each other (in the right and left direction in FIG. 5), cylindrical sound waves with narrow directivity, which is limited to about the width of the diaphragm 53A and the diaphragm 53B in the right and left direction, are emitted. Thus, the line sound source loudspeaker 5 is regarded as a line sound source with a predetermined length in the right and left direction in FIG. 5.

Thus, when the line sound source loudspeaker 5 is placed on the right and left sides of the listening position 100 in such a manner that the center axis direction along which cylindrical sound waves are outputted is oriented to the listening position 100, similarly to the examples illustrated in FIG. 1 to FIG. 4, direct sounds from the line sound source loudspeakers 5 (indirect sound components of audio sounds) hardly reach the listening position 100 and reflected sounds reflected by the wall surfaces, the ceiling, and the like in the room mainly reach the listening position 100.

Note that the height at which the line sound source loudspeaker 5 is placed is not limited to substantially the same height as the listening position 100, and may be the height close to the ceiling or floor, for example. The line sound source loudspeaker 5 emits sound waves with wide directivity that is about 180 degrees in the up and down direction. Therefore, when the line sound source loudspeaker 5 is placed close to the ceiling or floor around the listening position, sound emissions to the ceiling or floor are increased, and thus reflected sounds from the ceiling or floor are more increased. As a result, it is possible to provide a sound field such that indirect sound components (early-reflected sounds and reverberant sounds) resonate more efficiently.

Further, in this example, since a microphone 55 is disposed on the center axis along which the cylindrical sound waves are outputted, sounds that are outputted from the line sound source loudspeaker 5 to sneak into the microphone 55 are extremely few and howling can be suppressed.

Further, in this example, sound waves are emitted widely in the up and down direction, and thus more reflected sounds from the directions of ceiling and floor, (which are reflected sounds in which indirect sound components of audio sounds are reflected by the ceiling and floor), are contained, and thus it is possible to provide a sound field such that the indirect sound components resonate in the entire room.

Further, when the two line sound source loudspeakers 5 are placed in a manner to have rear surfaces thereof faced to each other, they output sounds in the front direction and the rear direction, resulting in that similarly to the examples illustrated in FIG. 1 and FIG. 4, it is possible to provide a sound field such that more indirect sound components resonate in the entire room.

Next, FIG. 6A is an appearance view of a sound field supporting device 1B according to a modified example 1, and FIG. 6B is a block diagram of the sound field supporting device 1B according to the modified example 1. The sound field supporting device 1B according to the modified example 1 is that plural microphones (a microphone 11A, a microphone 11B, and a microphone 11C) are placed on a support post 22. The microphone 11A, the microphone 11B, and the microphone 11C are all disposed in the plane same as that of a diaphragm of the planar loudspeaker 13. Further, as illustrated in FIG. 6B, the microphones are each connected to a switch 16 and output audio signals based on received sounds to the switch 16. An output signal of the switch 16 is inputted to the DSP 12. The other constitution of the sound field supporting device 1B is similar to that of the sound field supporting device illustrated in FIG. 2 and FIG. 3.

In this case, the controller 14 controls the switch 16 to periodically change over the microphone from which an audio signal is inputted to the DSP 12. The switch 16 outputs to the DSP 12 an audio signal based on a sound received by one of the microphones that is directed by the controller 14. This is sonically equivalent to the fact that position of the microphone is moved periodically, and thus frequency characteristics are averaged, thereby making it possible to further suppress howling.

Next, FIG. 7 is a block diagram of a sound field supporting device 1C according to a modified example 2. The sound field supporting device 1C according to the modified example 2 is that the DSP 12 includes an equalizer 121 and an indirect sound generator 122 functionally. The other constitution of the sound field supporting device 1C is similar to that of the sound field supporting device 1 illustrated in FIG. 3.

The indirect sound generator 122 generates an indirect sound component by delaying an inputted audio signal to output it as described above. The equalizer 121 is a filter to change a frequency characteristic of the inputted audio signal, and performs processing to suppress a gain in a predetermined frequency band here. The predetermined frequency band whose gain is suppressed is set when the sound field supporting device is placed. For example, the controller 14 makes the loudspeaker 13 output a test sound such as a white noise and measures a frequency characteristic of the sound received by the microphone 11. Then, the controller 14 sets a characteristic of the equalizer 121 so as to suppress a gain of a frequency band with the highest loop gain.

As described above, the sound field supporting device according to the modified example 2 controls a frequency characteristic of an inputted sound and suppresses a gain of a specific frequency band (a band with a high loop gain), thereby making it possible to more efficiently suppress howling.

Next, FIG. 8A is a block diagram of a sound field supporting device 1D according to a modified example 3. The sound field supporting device 1D according to the modified example 3 includes a user I/F 141 and a parameter storage 142. The other constitution of the sound field supporting device 1D is similar to that of the sound field supporting device 1 illustrated in FIG. 3.

The parameter storage 142 stores plural types of parameters (a delay time, a level, number of taps, and the like) of the DSP 12 therein. For example, three types of parameters, which are a setting in which a delay time of a reflected sound is long, a level is high, and number of taps is large (a setting of a first sound field effect), a setting in which a delay time of a reflected sound is short, a level is low, and number of taps is small (a setting of a second sound field effect), and an intermediate setting therebetween (a setting of a third sound field effect), are stored.

The user I/F 141 is a changeover switch or the like, and outputs an operation signal according to a changeover operation by a user to the controller 14. When receiving an operation signal according to the changeover operation from the user I/F 141, the controller 14 reads the parameter of the DSP 12 stored in the parameter storage 142 and changes the setting of the DSP 12. For example, every time the controller 14 receives an operation signal according to a changeover operation from the user I/F 14, the controller 14 changes over to the setting of the second sound field effect in the case of the setting of the first sound field effect is effective, changes over to the setting of the third sound field effect in the case of the setting of the second sound field effect is effective, and changes over to the setting of the first sound field effect in the case of the setting of the third sound field effect is effective, to thus change over the setting so that the sound field effect changes sequentially.

As the setting of the sound field effect, there is the following method, for example. That is, in the case where the sound source is based mainly on a human voice, the delay time is set to be short, the level is set to be low, and the number of taps is set to be small, thereby preferably preventing indirect sound components from being emphasized excessively. Meanwhile, in the case where the sound source is based mainly on a performance sound, the delay time is set to be long, the level is set to be high, and the number of taps is set to be large, thereby preferably supplying abundant indirect sound components. The delay time corresponds to density of reflected sounds, so that when the delay time is changed, the user perceives as if the size of the space were changed. The level corresponds to degree of sound absorption of the wall surface or the like in the room, so that when the level is changed, the user perceives as if construction materials in the room were changed. The number of taps corresponds to length of a long reverberant sound, so that when the number of taps is changed, a reverberation time is changed.

In the sound field supporting device 1D according to the modified example 3, acoustic characteristics of the indirect sound component are changed over in this manner, thereby making it possible to provide an appropriate sound field according to a usage environment, an intended purpose, a user's preference, or the like.

Next, FIG. 8B is a block diagram of a sound field supporting device 1E according to a modified example 4. The sound field supporting device 1E according to the modified example 4 includes a parameter storage 142, and the other constitution of the sound field supporting device 1E is similar to that of the sound field supporting device 1 illustrated in FIG. 3.

A controller 14 according to the modified example 4 analyses sounds received by the microphone 11 and performs an operation of automatically changing over the setting of the DSP 12. For example, when a signal corresponding to information specifying the parameter of the DSP 12 (identification information ID) is accumulated, on sounds of a content, in a band where sounds are not easily heard with human audibility, namely a band near the upper limit of an audio frequency (a band in the proximity of 10 kHz to 20 kHz, for example) and the controller 14 detects the identification information ID, the controller 14 reads the parameter according to the identification information ID from the parameter storage 142 to set it in the DSP 12. Alternatively, when extracting sounds in a specific frequency band, which are signal components specific to a musical instrument such as a piano or guitar for example (harmonic components or the like), the controller 14 reads the parameter enabling a sound field suitable for the musical instrument to be achieved to set it in the DSP 12.

In this manner, if the content is a video scene of a cave, for example, a setting to reproduce a sound field of the cave is performed, or the like, and according to the video scene of the content, an appropriate sound field can be provided.

Incidentally, in this example, an example where the controller 14 performs an analysis of an audio signal by software processing is described, but hardware (DSP) for performing the analysis may be prepared separately.

Incidentally, the modified examples 1 to 4 can also be implemented by combining the plural examples. Needless to say, they can also be implemented by combining all the examples.

Further, the modified examples 1 to 4 can be applied also to the line sound source loudspeaker illustrated in FIG. 5.

### REFERENCE SIGNS LIST

1 . . . sound field supporting device

11 . . . microphone

12 . . . DSP

13 . . . planar loudspeaker

14 . . . controller

16 . . . switch

21 . . . stand

22 . . . support post

23 . . . plate frame

50 . . . display

51 . . . main loudspeaker

1. A sound field supporting device comprising:
a loudspeaker whose directional characteristic is limited such that a sound wave is not outputted in a predetermined direction;
a microphone disposed in the direction for which the directional characteristic is limited; and
a signal processor configured to perform processing of inputting an audio signal representing a sound received by the microphone, generating a signal representing an indirect sound component based on the inputted audio signal, and outputting the signal via the loudspeaker.

2. The sound field supporting device according to claim 1, wherein
the loudspeaker is a planar loudspeaker that outputs a planar sound wave, and
the microphone is disposed in a plane same as that of a diaphragm of the planar loudspeaker.

3. The sound field supporting device according to claim 1, wherein
the loudspeaker is a line sound source loudspeaker that outputs a cylindrical sound wave, and
the microphone is disposed on an axis same as a center axis along which the cylindrical sound wave is outputted by the line sound source loudspeaker.

4. The sound field supporting device according to claim 1, wherein
the microphone is a directional microphone.

5. A sound field supporting system wherein
the sound field supporting device according to claim 1 is placed around a listening position, and
the sound field supporting system is constructed such that a wall surface is arranged in a direction in which the loudspeaker outputs a sound.

6. The sound field supporting system according to claim 5, constructed such that the listening position is disposed at a position for which the directional characteristic of the loudspeaker is limited.
